(19) United States
(12) Patent Application Publication
(10) Pub. No.: US 2026/0336538 A1
(43) Pub. Date: Oct. 29, 2026

(54) WIRE HARNESS AND ELECTRIC WIRE FIXING MEMBER

(71) Applicants: SUMITOMO WIRING SYSTEMS, LTD., Yokkaichi-shi (JP); TOYOTA JIDOSHA KABUSHIKI KAISHA, Toyota-shi (JP)

(72) Inventors: Toshiki NAKAI, Yokkaichi-shi (JP); Kazuma HIKITA, Yokkaichi-shi (JP); Yusuke SAITO, Toyota-shi (JP); Takayuki MIYAKE, Toyota-shi (JP)

(21) Appl. No.: 19/650,344

(22) Filed: Apr. 17, 2026

(30) Foreign Application Priority Data
Apr. 25, 2025 (JP) 2025-073215

(51) Int. Cl. B60R 16/02; H01B 7/00; H02G 3/32

(52) U.S. Cl. CPC B60R 16/0215; H01B 7/0045; H02G 3/32

(57) ABSTRACT

A wire harness includes an electric wire member, a corrugated tube including large-diameter portions and small-diameter portions that are tubular and alternately continuous with one another along an extension direction of the corrugated tube to cover the periphery of the electric wire member, an inner protector including an inner main body covering the periphery of a portion of the corrugated tube in the extension direction and a restriction projection inserted between the large-diameter portions to restrict movement of the corrugated tube in the extension direction of the corrugated tube, an elastic member covering the periphery of the inner protector and holding the inner protector, and an outer protector including an elastic member holder covering the periphery of the elastic member and holding the elastic member and a fixing portion used for fixation to a subject.

### CROSS-REFERENCE TO RELATED APPLICATIONS

This application is based upon and claims the benefit of priority from Japanese Patent Application No. 2025-073215, filed on Apr. 25, 2025, the entire contents of which are incorporated herein by reference.

### BACKGROUND

### 1. Field

The following description relates to a wire harness and an electric wire fixing member.

### 2. Description of Related Art

JP7396453B discloses an example of a typical wire harness that includes an electric wire member and an electric wire fixing member. The electric wire fixing member is used to fix the electric wire member to a subject. In the wire harness, the periphery of the electric wire member includes an undulated surface. The electric wire fixing member includes an elastic member pressed against the undulated surface. In this structure, since the electric wire member is elastically held by the elastic member, application of an instantaneous large force to the electric wire member is limited. The structure also limits displacement of the electric wire member relative to the fixation subject in the extension direction of the electric wire member.

When the wire harness is used in a vehicle to connect an inverter to a motor that is configured to drive a wheel, an electric wire member having a relatively large diameter may vibrate greatly. In such a case, with a structure that merely presses the elastic member against the undulated surface of the electric wire member to hold the electric wire member, the electric wire member may be displaced in the extension direction of the electric wire member relative to the fixation subject such as a vehicle body panel. Further, such displacement may cause the electric wire member to come in contact with another member, for example, when the electric wire member vibrates.

It is an object of the present disclosure to provide a wire harness and an electric wire fixing member that reliably restricts displacement of an electric wire member in the extension direction of the electric wire member relative to a subject to which the electric wire member is fixed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A wire harness according to the present disclosure includes an electric wire member, a corrugated tube including large-diameter portions and small-diameter portions that are tubular and alternately continuous with one another along an extension direction of the corrugated tube, the corrugated tube covering a periphery of the electric wire member, an inner protector including an inner main body and a restriction projection, the inner main body covering a periphery of a portion of the corrugated tube in the extension direction, and the restriction projection being inserted between the large-diameter portions to restrict movement of the corrugated tube in the extension direction, an elastic member covering a periphery of the inner protector and holding the inner protector, and an outer protector including an elastic member holder and a fixing portion. The elastic member holder covers a periphery of the elastic member and holds the elastic member. The fixing portion is used for fixation to a subject.

### Advantageous Effects of Invention

The wire harness and the electric wire fixing member according to the present disclosure reliably restricts displacement of the electric wire member relative to the fixation subject in the extension direction of the electric wire member.

Other features and aspects will be apparent from the following detailed description, the drawings, and the claims.

### BRIEF DESCRIPTION OF THE DRAWINGS

FIG. 1 is a perspective view showing part of a wire harness in one embodiment.

FIG. 2 is an exploded perspective view of an electric wire fixing member in one embodiment.

FIG. 3 is an exploded perspective view of an electric wire fixing member in one embodiment.

FIG. 4 is a front view of an electric wire fixing member in one embodiment.

FIG. 5 is a cross-sectional view of an electric wire fixing member in one embodiment.

FIG. 6 is a cross-sectional view of a wire harness taken along line 6-6 in FIG. 5.

Throughout the drawings and the detailed description, the same reference numerals refer to the same elements.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Description of Embodiments of Present Disclosure

Aspects of the present disclosure will be described below.
[1] A wire harness according to the present disclosure includes an electric wire member, a corrugated tube including large-diameter portions and small-diameter portions that are tubular and alternately continuous with one another along an extension direction of the corrugated tube, the corrugated tube covering a periphery of the electric wire member, an inner protector including an inner main body and a restriction projection, the inner main body covering a periphery of a portion of the corrugated tube in the extension direction, and the restriction projection being inserted between the large-diameter portions to restrict movement of the corrugated tube in the extension direction, an elastic member covering a periphery of the inner protector and holding the inner protector, and an outer protector including an elastic member holder and a fixing portion. The elastic member holder covers a periphery of the elastic member and holds the elastic member. The fixing portion is used for fixation to a subject.
In this structure, the corrugated tube, which covers the periphery of the electric wire member, is fixed to the subject by the inner protector, the elastic member, and the outer protector. The electric wire member and the corrugated tube are elastically held by the elastic member. Therefore, application of an instantaneous large force to the electric wire member and the corrugated tube is limited. The inner protector includes the restriction projection inserted between the large-diameter portions of the corrugated tube to restrict movement of the corrugated tube in the extension direction. Therefore, displacement of the electric wire member and the corrugated tube relative to the fixation subject in the extension direction of the electric wire member and the corrugated tube is reliably restricted.
[2] In aspect [1], the electric wire member may be one of multiple electric wire members, the corrugated tube may be one of multiple corrugated tubes, the inner protector may be one of multiple inner protectors, the elastic member may be one of multiple elastic members, and the elastic member holder may be one of multiple elastic member holders separately holding the elastic members.
The above structure, in which the outer protector includes the multiple elastic member holders separately holding the multiple elastic members, limits, for example, the effect of elastic deformation of an elastic member on the functionality of another elastic member. For example, if an elastic member holder collectively holds multiple elastic members, adjacent ones of the elastic members may be in contact with each other, and elastic deformation of an elastic member may affect the functionality of another elastic member. Such a shortcoming is avoided in the above structure.
[3] In aspect [1] or [2], the inner protector may include two inner members fixed to each other while sandwiching a periphery of the corrugated tube. The inner members may be identical in shape.
The above structure, in which the inner protector includes two inner members that are identical in shape and fixed to each other while sandwiching the periphery of the corrugated tube, for example, simplifies the manufacturing of the inner protector. For example, if the two inner members differ in shape, each inner member may need to be formed using a different mold, and the costs may increase. This is avoided in the above structure.
[4] In any of aspects [1] to [3], the inner protector may be formed from a resin material.
The structure, in which the inner protector is formed from a resin material, is, for example, less likely to damage the corrugated tube.
[5] In any of aspects [1] to [4], the outer protector may be formed from a metal material.
With the structure, since the outer protector is formed from a metal material, for example, the outer protector is firmly fixed to the subject.
[6] An electric wire fixing member according to the present disclosure is used for fixation of a corrugated tube to a subject. The corrugated tube includes large-diameter portions and small-diameter portions that are tubular and alternately continuous with one another along an extension direction of the corrugated tube. The corrugated tube covers a periphery of an electric wire member. The electric wire fixing member includes an inner protector including an inner main body and a restriction projection, the inner main body covering a periphery of a portion of the corrugated tube in the extension direction, the restriction projection being inserted between the large-diameter portions to restrict movement of the corrugated tube in the extension direction, an elastic member covering a periphery of the inner protector and holding the inner protector, and an outer protector including an elastic member holder and a fixing portion. The elastic member holder covers a periphery of the elastic member and holds the elastic member. The fixing portion is used for fixture to the subject.
In this structure, the corrugated tube, which covers the periphery of the electric wire member, is fixed to the subject by the inner protector, the elastic member, and the outer protector. The electric wire member and the corrugated tube are elastically held by the elastic member. Therefore, application of an instantaneous large force to the electric wire member and the corrugated tube is limited. The inner protector includes the restriction projection inserted between the large-diameter portions of the corrugated tube to restrict movement of the corrugated tube in the extension direction. Therefore, displacement of the electric wire member and the corrugated tube relative to the fixation subject in the extension direction of the electric wire member and the corrugated tube is reliably restricted.

### Detailed Description of Embodiments of Present Disclosure

Specific examples of a wire harness according to the present disclosure will be described below with reference to the drawings. In the drawings, components are shown for illustrative purposes and may be partially exaggerated or omitted. The dimensional ratio of the components may differ between the drawings.

The term “tubular” as used in this description is not limited to a structure formed by a circumferential wall continuously extending along the entire circumference and also includes a structure formed to be cylindrical by a combination of multiple parts or a structure in which a cutout is formed in the circumferential wall such as a C-shape. A peripheral shape of an “tubular” object includes, but is not limited to, a circular shape, an elliptical shape, and a polygonal shape with sharp or rounded corners. The term “tubular” includes a shape having a through hole in plan view, and includes a shape in which the outer circumference and the inner circumference defining the through hole are identical in shape, and a shape in which the outer circumference and the inner circumference defining the through hole differ in shape from each other. The “tubular” includes a shape having a predetermined length in an axial direction in which the axis extends through the center of the through hole. The length is not particularly limited.

Terms such as “first” and “second” are used in this specification to distinguish subjects and not used for ordinal purposes.

The present disclosure is not limited to those exemplified and is shown by the scope of the claims. It is intended to include all modifications within the meaning and range equivalent to the scope of the claims.

### Structure of Wire Harness 10

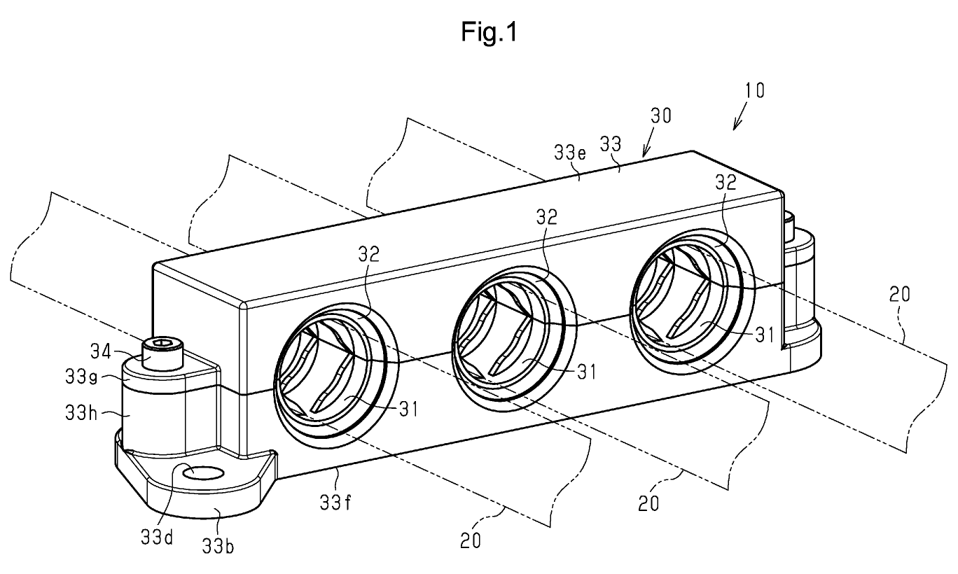

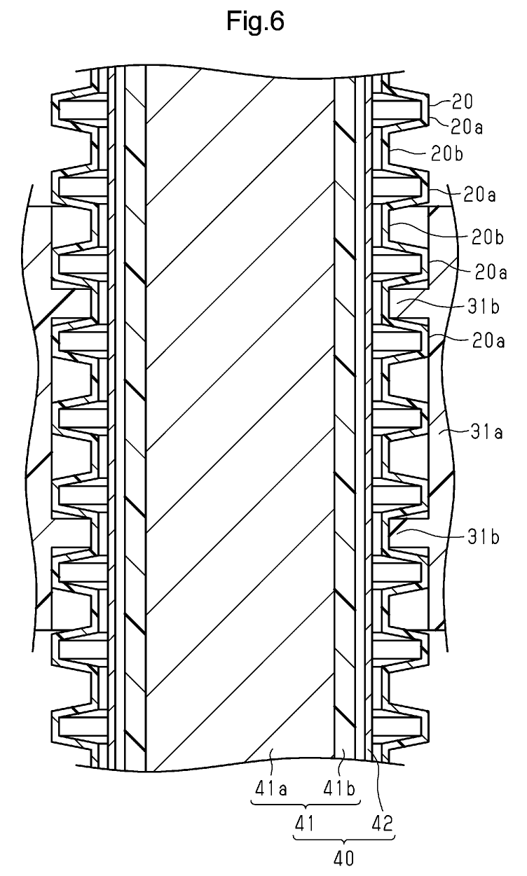

As shown in FIG. 1, a wire harness 10 includes a corrugated tube 20 and an electric wire fixing member 30 used for fixture of the corrugated tube 20 to a subject (not shown) such as a vehicle body panel. The wire harness 10 further includes an electric wire member 40 (refer to FIG. 6). The periphery of the electric wire member 40 is covered by the corrugated tube 20. In the present embodiment, the wire harness 10 includes three corrugated tubes 20 and three electric wire members 40 respectively covered by the corrugated tubes 20. In the present embodiment, the wire harness 10 is used to connect an inverter (not shown) mounted on a vehicle to a motor (not shown) configured to drive a wheel.

### Structure of the Electric Wire Member 40

As shown in FIG. 6, in the present embodiment, the electric wire member 40 includes an electric wire 41 and a braided wire 42 covering the periphery of the electric wire 41. That is, in the present embodiment, the electric wire member 40 is a shield cable.

### Structure of the Electric Wire 41

The electric wire 41 is a coated wire that includes a conductive core wire 41a and an insulating cover 41b covering the periphery of the core wire 41a.

The core wire 41a includes, for example, a single-core wire or a stranded wire, which is formed by twisting conductive strands together. The core wire 41a is formed from, for example, a metal material that is copper-based, aluminum-based, or the like. In the present embodiment, the core wire 41a has a transverse cross section that is true circular.

The insulating cover 41b entirely covers the peripheral surface of the core wire 41a in the circumferential direction. The insulating cover 41b is formed from an insulating material, for example, synthetic resin including a polyolefin-based resin, such as cross-linked polyethylene or cross-linked polypropylene, as a main component.

### Structure of the Braided Wire 42

The braided wire 42 is formed by braiding conductive strands. The material of the braided wire 42 may be, for example, a metal material that is copper-based, aluminum-based, or the like. The drawings do not show a braided state of the strands in the braided wire 42 and, instead, schematically show the braided wire 42. Each end of the braided wire 42 is directly or indirectly connected to a ground member (not shown) such as a vehicle body or a metal case.

### Structure of the Corrugated Tube 20

The corrugated tube 20 is formed from an insulating resin material. The corrugated tube 20 is tubular and covers the periphery of the electric wire member 40. The corrugated tube 20 has an accordion structure in which large-diameter portions 20a and small-diameter portions 20b are tubular and alternately continuous with one another in an extension direction. The extension direction of the corrugated tube 20 and the electric wire member 40 refers to, for example, a direction from the upper side toward the lower side in FIG. 6.

### Structure of the Electric Wire Fixing Member 30

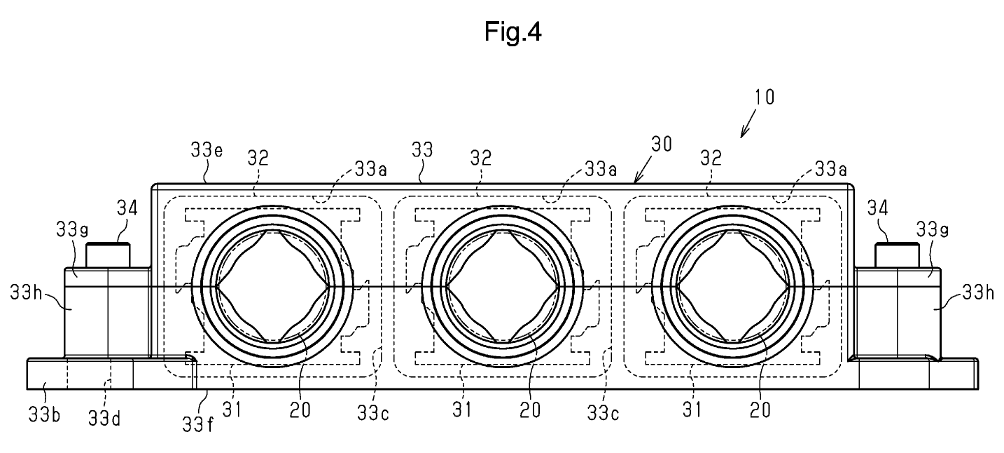

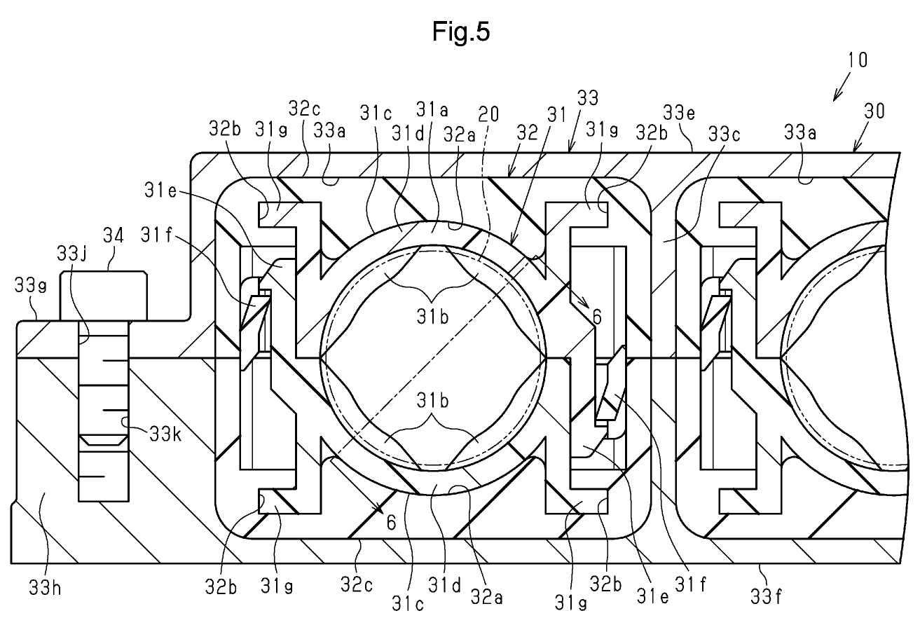

As shown in FIGS. 4 and 5, the electric wire fixing member 30 includes an inner protector 31, an elastic member 32, and an outer protector 33. As shown in FIG. 4, in the present embodiment, the electric wire fixing member 30 includes three inner protectors 31 and three elastic members 32 in conformance with the number of corrugated tubes 20.

### Structure of the Inner Protector 31

As shown in FIG. 5, the inner protector 31 includes an inner main body 31a and a restriction projection 31b. The inner protector 31 is formed from a resin material. The inner main body 31a covers the periphery of a portion of the corrugated tube 20 in the extension direction. As shown in FIG. 6, the restriction projections 31b are inserted between the large-diameter portions 20a of the corrugated tube 20 to restrict movement of the corrugated tube 20 in the extension direction of the corrugated tube 20. As shown in FIG. 5, in the present embodiment, four restriction projections 31b are arranged next to one another on the inner circumference of the inner main body 31a in the circumferential direction. In addition, as shown in FIG. 6, in the present embodiment, two restriction projections 31b are arranged next to each other in the extension direction of the inner main body 31a.

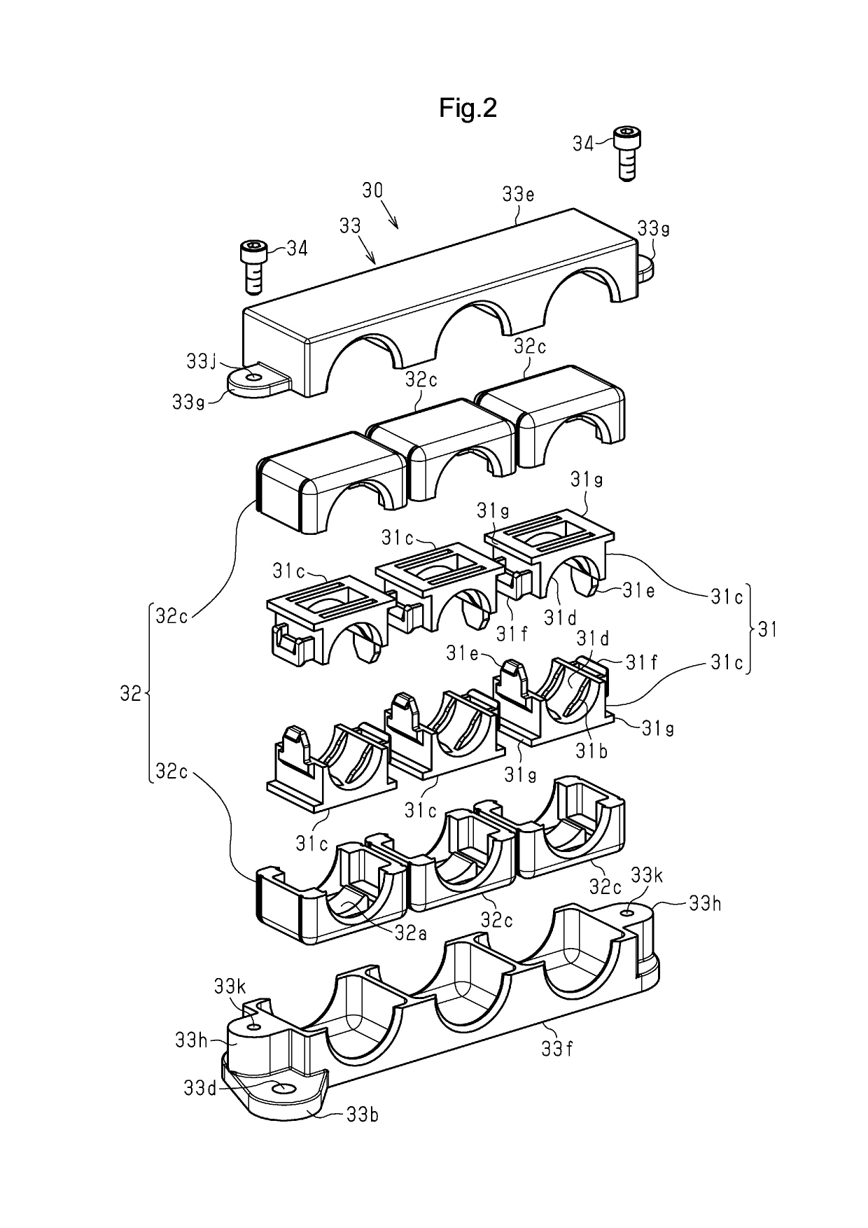

As shown in FIGS. 2, 3, and 5, each inner protector 31 includes two inner members 31c. The two inner members 31c are fixed to each other while sandwiching the periphery of the corrugated tube 20 (refer to FIG. 5).

More specifically, in the inner protector 31, the two inner members 31c are identical in shape. In the present embodiment, the inner members 31c each include an arc-shaped portion 31d having the form of an arc forming one half of the inner main body 31a, a hook 31e arranged on a first end of the arc-shaped portion 31d, and a hooked portion 31f arranged on a second end of the arc-shaped portion 31d. The two inner members 31c are coupled so that the inner circumferences of the arc-shaped portions 31d form a circle and the hook 31e engages the hooked portion 31f. This forms the inner protector 31.

As shown in FIG. 5, in the present embodiment, the inner members 31c each include two legs 31g extending from the first end and the second end of the arc-shaped portion 31d. The two legs 31g extend in a direction opposite to the coupling direction of the two inner members 31c. Further, the distal ends of the two legs 31g are bent and extend away from each other.

### Structure of the Elastic Member 32

The elastic member 32 covers the periphery of the inner protector 31 and holds the inner protector 31. The elastic member 32 is formed from a rubber material. The elastic member 32 includes a contact portion 32a in contact with the outer circumferential surface of each arc-shaped portion 31d of the inner protector 31 and a holder 32b receiving and holding the distal end of each leg 31g.

As shown in FIGS. 2, 3, and 5, the elastic member 32 includes two elastic pieces 32c. The elastic pieces 32c are each configured to be fixed to one of the inner members 31c.

As shown in FIG. 5, the two elastic pieces 32c of the elastic member 32 are identical in shape and each include one contact portion 32a and two holders 32b. The elastic member 32, formed of the two elastic pieces 32c, has the form of a rectangle with rounded corners as viewed in the extension direction of the corrugated tube 20.

### Structure of the Outer Protector 33

As shown in FIG. 4, the outer protector 33 includes an elastic member holder 33a and a fixing portion 33b. The outer protector 33 is formed from a metal material. The elastic member holder 33a covers the periphery of the elastic member 32 and holds the elastic member 32. The fixing portion 33b is configured to be fixed to a subject (not shown) such as the vehicle body panel.

In the present embodiment, the outer protector 33 includes multiple elastic member holders 33a separately holding multiple elastic members 32. More specifically, as shown in FIG. 5, the outer protector 33 includes a partition wall 33c arranged between the elastic member holders 33a so that the elastic members 32 do not contact each other. In the present embodiment, the outer protector 33 includes three elastic member holders 33a in conformance with the number of elastic members 32.

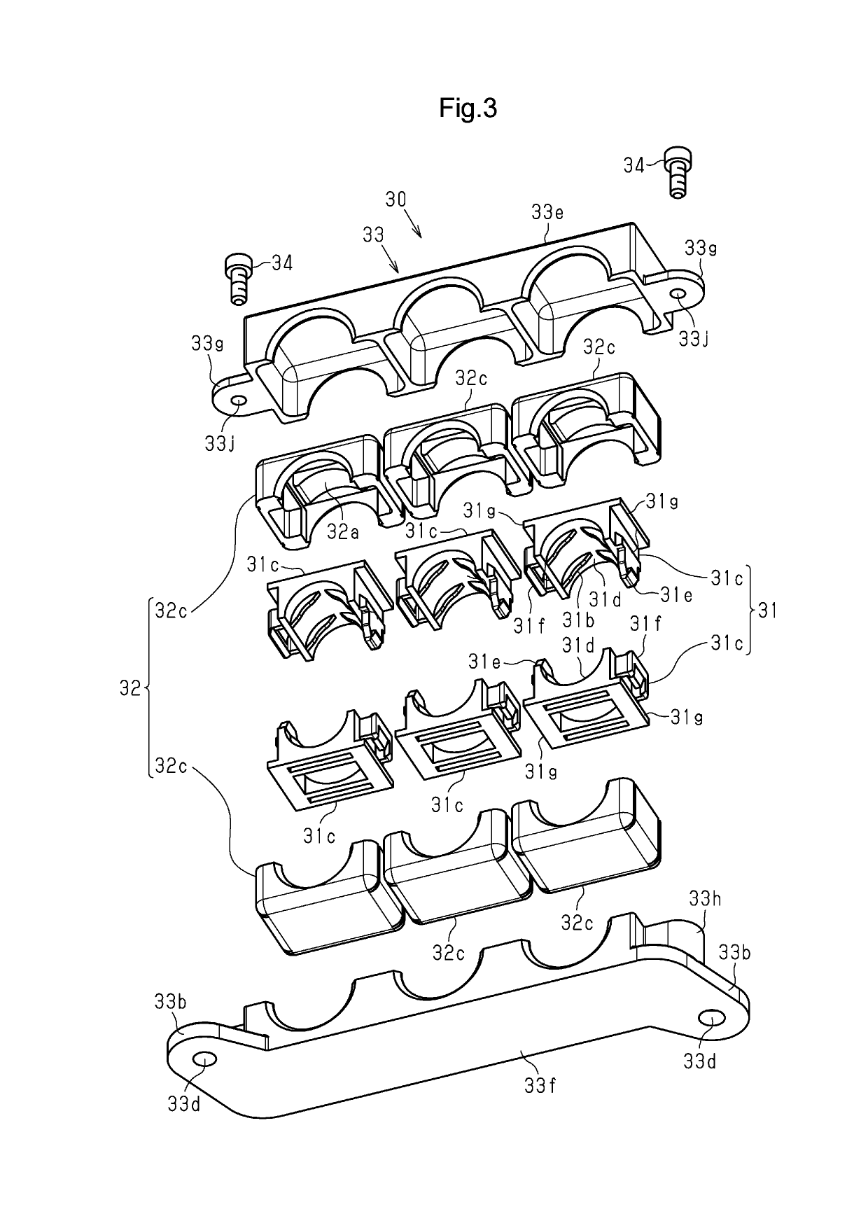

As shown in FIG. 1, each fixing portion 33b has a fixing hole 33d. As shown in FIG. 3, the fixing portions 33b are located at opposite sides of the outer protector 33 in a direction in which the elastic member holders 33a are arranged. Each fixing portion 33b is fixed to a subject, for example, when a bolt is inserted through the fixing hole 33d and fastened to the fixation subject.

As shown in FIGS. 2-5, the outer protector 33 includes a first outer member 33e and a second outer member 33f. The first outer member 33e and the second outer member 33f are fixed to each other while sandwiching the periphery of the three elastic members 32.

More specifically, the first outer member 33e forms the upper half of each of the elastic member holders 33a and has opposite ends, each of which includes a first fixing portion 33g. The second outer member 33f forms the lower half of each of the elastic member holders 33a and has opposite ends, each of which includes a second fixing portion 33h and the fixing portions 33b (described above). As shown in FIG. 5, the first fixing portion 33g has a through hole 33j. The second fixing portion 33h has internal threads 33k. When a bolt 34 is inserted through the through hole 33j and coupled to the internal threads 33k, the first outer member 33e and the second outer member 33f are fixed by the bolt 34 to form the outer protector 33.

### Operation of the Wire Harness 10

The wire harness 10 having the structure described above, for example, electrically connects an inverter (not shown) mounted on a vehicle and a motor (not shown) configured to drive a wheel. In the wire harness 10, intermediate portions of the electric wire member 40 and the corrugated tube 20 in the extension direction are fixed by the electric wire fixing member 30 to a subject (not shown) such as the vehicle body panel. Thus, for example, a large vibration of the electric wire member 40 and the corrugated tube 20 is restricted. This ultimately restricts the electric wire member 40 and the corrugated tube 20 from contacting another member.

### Advantages of the Present Embodiment

(1) The corrugated tube 20, which covers the periphery of the electric wire member 40, is fixed to a subject by the inner protector 31, the elastic member 32, and the outer protector 33. More specifically, the corrugated tube 20, covering the periphery of the electric wire member 40, is held by the inner protector 31. The inner protector 31 is held by the elastic member 32. The elastic member 32 is held by the outer protector 33. The outer protector 33 is fixed to the subject. In this structure, the electric wire member 40 and the corrugated tube 20 are elastically held by the elastic member 32. This limits application of an instantaneous large force to the electric wire member 40 and the corrugated tube 20. In addition, the inner protector 31 includes the restriction projection 31b inserted between the large-diameter portions 20a of the corrugated tube 20 to restrict movement of the corrugated tube 20 in the extension direction of the corrugated tube 20. This reliably restricts displacement of the electric wire member 40 and the corrugated tube 20 relative to the fixation subject in the extension direction of the electric wire member 40 and the corrugated tube 20. Thus, for example, a large vibration of the electric wire member 40 and the corrugated tube 20 is reliably restricted. This ultimately restricts the electric wire member 40 and the corrugated tube 20 from contacting another member.
(2) The outer protector 33 includes the multiple elastic member holders 33a separately holding the multiple elastic members 32. This limits, for example, the effect of elastic deformation of an elastic member 32 on the functionality of another elastic member 32. For example, if an elastic member holder 33a collectively holds multiple elastic members 32, adjacent ones of the elastic members 32 may be in contact with each other. In such a structure, elastic deformation of an elastic member 32 may affect the functionality of another elastic member 32, which is avoided in the embodiment.
(3) The inner protector 31 includes the two inner members 31c fixed to each other while sandwiching the periphery of the corrugated tube 20. The inner members 31c are identical in shape. This simplifies the manufacturing of, for example, the inner protector 31. For example, if the two inner members 31c differ in shape, each inner member may need to be formed using a different mold, and the costs may increase. This is avoided in the embodiment.
(4) The inner protector 31 is formed from a resin material and thus is, for example, less likely to damage the corrugated tube 20.
(5) The outer protector 33 is formed from a metal material and thus is, for example, firmly fixed to the subject.

### Modified Examples

The embodiment described above may be modified as follows. The above-described embodiment and the following modified examples can be combined as long as the combined modified examples remain technically consistent with each other.

In the embodiment, the outer protector 33 includes multiple elastic member holders 33a separately holding multiple elastic members 32. Instead, for example, an elastic member holder may collectively hold multiple elastic members 32. More specifically, the partition wall 33c may be omitted, and the outer protector 33 may be configured to hold the elastic members 32 so that adjacent ones of the elastic members 32 are in contact with each other. Also, for example, the three elastic members 32 of the embodiment may be changed to a single elastic member holding three inner protectors 31. The outer protector 33 may include an elastic member holder holding the single elastic member.

In the embodiment, the two inner members 31c of the inner protector 31 are identical in shape. Alternatively, the two inner members 31c may differ in shape from each other.

In the embodiment, the inner protector 31 is formed from a resin material. Alternatively, the inner protector 31 may be formed from any material that is harder than the elastic member 32 and may be formed from, for example, a metal material.

In the embodiment, the outer protector 33 is formed from a metal material. Alternatively, the outer protector 33 may be formed from any material that is harder than the elastic member 32 and may be formed from, for example, a resin material.

In the embodiment, the wire harness 10 includes three corrugated tubes 20, and three inner protectors 31 and three elastic members 32 in conformance with the three corrugated tubes 20. However, each number may be changed. In the embodiment, each corrugated tube 20 covers a single electric wire member 40. Alternatively, each corrugated tube 20 may cover multiple electric wire members 40.

In the embodiment, the electric wire member 40 is a shield cable including the electric wire 41 and the tubular braided wire 42 covering the periphery of the electric wire 41. Alternatively, for example, the electric wire 41 may be simplified by omitting the braided wire 42.

The structure of the inner protector 31 may be changed from that of the embodiment. The inner protector 31 may include, for example, inner members coupled to each other by a thin hinge. The periphery of the corrugated tube 20 may be sandwiched by the inner members. For example, in the inner protector 31, the shape and number of the restriction projections 31b may be changed.

The structure of the elastic member 32 may be changed from that of the embodiment. The elastic member 32 may include, for example, elastic pieces coupled to each other by a thin hinge. The periphery of the inner protector 31 may be sandwiched by the elastic pieces.

In the embodiment, the contact portion 32a of each elastic piece 32c may be disposed between the two legs 31g of the inner member 31c, and the inner circumferential surface of the contact portion 32a may have a shape extending along the outer circumferential surface of the arc-shaped portion 31d. Further, the two holders 32b of each elastic piece 32c may be disposed radially outward of the elastic member 32 relative to the contact portion 32a and may be configured to face the distal ends of the two legs 31g of the inner member 31c in the coupling direction. Accordingly, the two holders 32b may restrict displacement of the inner member 31c relative to the elastic piece 32c in the coupling direction.

The embodiment and modified examples disclosed herein are examples in all respects, and the present invention is not limited to these examples. That is, the scope of the present invention is indicated by the claims, and is intended to include any equivalence to the claims and any modification that is within the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A wire harness, comprising:
an electric wire member;
a corrugated tube including large-diameter portions and small-diameter portions that are tubular and alternately continuous with one another along an extension direction of the corrugated tube, the corrugated tube covering a periphery of the electric wire member;
an inner protector including an inner main body and a restriction projection, the inner main body covering a periphery of a portion of the corrugated tube in the extension direction of the corrugated tube, and the restriction projection being inserted between the large-diameter portions to restrict movement of the corrugated tube in the extension direction;
an elastic member covering a periphery of the inner protector and holding the inner protector; and
an outer protector including an elastic member holder and a fixing portion, the elastic member holder covering a periphery of the elastic member and holding the elastic member, and the fixing portion being used for fixation to a subject.

2. The wire harness according to claim 1, wherein
the electric wire member is one of multiple electric wire members,
the corrugated tube is one of multiple corrugated tubes,
the inner protector is one of multiple inner protectors,
the elastic member is one of multiple elastic members, and
the elastic member holder is one of multiple elastic member holders separately holding the elastic members.

3. The wire harness according to claim 1, wherein
the inner protector includes two inner members fixed to each other while sandwiching a periphery of the corrugated tube, and
the inner members are identical in shape.

4. The wire harness according to claim 1, wherein the inner protector is formed from a resin material.

5. The wire harness according to claim 1, wherein the outer protector is formed from a metal material.

6. An electric wire fixing member used for fixation of a corrugated tube to a subject, the corrugated tube including large-diameter portions and small-diameter portions that are tubular and alternately continuous with one another along an extension direction of the corrugated tube, the corrugated tube covering a periphery of an electric wire member, the electric wire fixing member, comprising:
an inner protector including an inner main body and a restriction projection, the inner main body covering a periphery of a portion of the corrugated tube in the extension direction, and the restriction projection being inserted between the large-diameter portions to restrict movement of the corrugated tube in the extension direction;
an elastic member covering a periphery of the inner protector and holding the inner protector; and
an outer protector including an elastic member holder and a fixing portion, the elastic member holder covering a periphery of the elastic member and holding the elastic
member, and the fixing portion being used for fixture to the subject.
